(19) United States
(12) Patent Application Publication
(10) Pub. No.: US 2017/0041475 A1
(43) Pub. Date: Feb. 9, 2017

(54) METHOD AND IMAGE FORMING DEVICE FOR SHARING PERSONALIZATION DATA

(71) Applicant: Samsung Electronics Co., Ltd., Suwon-si (KR)

(72) Inventors: Cheol-yon WON, Seoul (KR); Vijay DHOOT, Suwon-si (KR)

(21) Appl. No.: 15/219,877

(22) Filed: Jul. 26, 2016

(30) Foreign Application Priority Data
Aug. 4, 2015 (KR) 10-2015-0110239
Jul. 1, 2016 (KR) 10-2016-0083531

(51) Int. Cl. H04N 1/00; H04N 1/32

(52) U.S. Cl. CPC H04N 1/00514; H04N 1/00347; H04N 1/32101; H04N 1/32523; H04N 2201/0094; H04N 2201/3205

(57) ABSTRACT

A method of sharing personalization data in a first image forming device is provided. The method includes receiving user identification information for user login from a user, identifying a second image forming device connected to the first image forming device, receiving the personalization data from the second image forming device based on the received user identification information, and providing a user interface to which the received personalization data is applied.

### CROSS-REFERENCE TO RELATED APPLICATION(S)

This application claims the benefit under 35 U.S.C. §119(a) of a Korean patent application filed on Aug. 4, 2015 in the Korean Intellectual Property Office and assigned Serial number 10-2015-0110239, and of a Korean patent application filed on Jul. 1, 2016 in the Korean Intellectual Property Office and assigned Serial number 10-2016-0083531, the entire disclosure of each of which is hereby incorporated by reference.

### TECHNICAL FIELD

The present disclosure relates to a method and an image forming device for sharing personalization data.

### BACKGROUND

Examples of an image forming device include individual devices, such as a printer, a scanner, a copier, a fax machine, etc., and a multi-function product (MFP) that integrates various types of functions of such different devices into one device. Image forming devices as mentioned above may include a wired communication module such as Ethernet or the like and a wireless communication module such as Wi-Fi, Wi-Fi Direct, near field communication (NFC), Bluetooth, Zigbee, infrared data association (IrDA), or the like to be connected to other types of user devices such as a mobile device, a notebook computer, etc. and other types of image forming devices through a network. Also, the image forming devices may access a cloud server by using modules as mentioned above to perform operations of uploading or downloading documents to or from the cloud server.

There is a need for methods of providing a job environment appropriate for a user in an image forming device used by a plurality of users in an enterprise network.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an image forming device for sharing personalization data.

Another aspect of the present disclosure is to provide a non-transitory computer readable recording medium having recorded thereon a program for executing the method in a computer.

In accordance with an aspect of the present disclosure, a method of sharing personalization data in a first image forming device is provided. The method includes receiving user identification information for user login from a user, identifying a second image forming device connected to the first image forming device, receiving the personalization data from the second image forming device based on the received user identification information, and providing a user interface to which the received personalization data is applied.

The method may further include if the user login ends, updating the personalization data in the second image forming device based on the user identification information.

The method may further include receiving location information of a personal storage device of the user from the second image forming device based on the user identification information and receiving image forming job data from the third image forming device according to the received location information.

The method may further include receiving location information of a personal storage device of the user from the second image forming device based on the user identification information and transmitting image forming job data to the second image forming device or the third image forming device according to the received location information.

The providing of the user interface may include changing at least one of an application provided from the user interface, a current state of the application, and a setting of the application, based on the received personalization data.

The identifying of the second image forming device may include identifying the second image forming device connected to the first image forming device based on the user identification information.

The identifying of the second image forming device may include identifying the second image forming device connected to the first image forming device based on pre-stored identification information of the second image forming device.

The method may further include performing authentication of the user based on the received user identification information. If the authentication succeeds, a user interface to which the received personalization data is applied may be provided.

In accordance with another aspect of the present disclosure, a method of sharing personalization data in a first image forming device is provided. The method includes receiving user identification information for user login from a user terminal, performing user authentication based on the received user identification information, transmitting, if the user authentication succeeds, personalization data corresponding to the user identification information, receiving an image forming job request, which is received from the user through the user interface to which the personalization data is applied, from the user terminal, and performing an image forming job according to the received image forming job request.

In accordance with another aspect of the present disclosure, a first image forming device is provided. The first image forming device includes a user interface unit configured to receive user identification information for user login from a user, a communicator configured to receive personalization data from a second image forming device based on the received user identification information, and a processor configured to identify the second image forming device connected to the first image forming device and control providing of a user interface to which the received personalization data is applied.

If the user login ends, the processor may control updating of the personalization data in the second image forming device based on the user identification information.

The communicator may receive location information of a personal storage device of the user from the second image forming device based on the user identification information. The processor may control receiving of image forming job data from a third image forming device according to the received location information.

The communicator may receive location information of a personal storage device of the user from the second image forming device based on the user identification information. The processor may control transmitting of image forming job data to the second image forming device or a third image forming device according to the received location information.

The processor may change at least one of an application provided from the user interface, a current state of the application, and a setting of the application, based on the received personalization data.

The processor may identify the second image forming device connected to the first image forming device based on the user identification information.

The processor may identify the second image forming device connected to the first image forming device based on pre-stored identification information of the second image forming device.

The processor may perform authentication of the user based on the received user identification information and, if the authentication succeeds, control providing of a user interface to which the received personalization data is applied.

In accordance with another aspect of the present disclosure, a first image forming device is provided. The first image forming device includes a communicator configured to receive user identification information for user login from a user terminal and a processor configured to perform user authentication based on the received user identification information and, if the user authentication succeeds, control transmitting of personalization data corresponding to the user identification information. If an image forming job request, which is received from a user through the user interface to which the personalization data is applied, is received from the user terminal, the processor may perform an image forming job according to the image forming job request.

In accordance with another aspect of the present disclosure, a method of sharing setting data in a second image forming device is provided. The method includes receiving a request for setting data from a first image forming device connected to the second image forming device, determining setting data, which is to be transmitted to the first image forming device, among the setting data including at least one of personalization data and generalization data, based on version information of setting data of the second image forming device, and transmitting the determined setting data to the first image forming device.

In accordance with another aspect of the present disclosure, a second image forming device is provided. The second image forming device includes a communicator configured to receive a request for setting data from a first image forming device connected to the second image forming device and a processor configured to determine setting data, which is to be transmitted to the first image forming device, among the setting data including at least one of personalization data and generalization data, based on version information of setting data of the second image forming device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a printing system for sharing personalization data according to an embodiment of the present disclosure;

FIG. 2 illustrates a process of providing a user interface by using personalization data shared in a first image forming device according to an embodiment of the present disclosure;

FIG. 3 illustrates a process of sharing personalization data in a first image forming device according to an embodiment of the present disclosure;

FIG. 4 illustrates a process of setting an environment for sharing personalization data in an image forming device of a printing system according to an embodiment of the present disclosure;

FIG. 5 illustrates a printing system for sharing personalization data according to an embodiment of the present disclosure;

FIG. 6 illustrates a process of managing a personal storage device of a user in a first image forming device according to an embodiment of the present disclosure;

FIG. 7 illustrates a printing system for sharing personalization data according to an embodiment of the present disclosure;

FIG. 8 is a flowchart of a method of sharing personalization data in a first image forming device according to an embodiment of the present disclosure;

FIG. 9 is a block diagram of a configuration of an image forming device for sharing personalization data according to an embodiment of the present disclosure;

FIG. 10 illustrates a printing system for sharing setting data according to an embodiment of the present disclosure;

FIG. 11 illustrates generalization data used in the printing system of FIG. 10 according to an embodiment of the present disclosure;

FIG. 12 is a sequence diagram of a method of sharing setting data in the printing system of FIG. 10 according to an embodiment of the present disclosure;

FIG. 13 is a flowchart of a method of sharing setting data the printing system of FIG. 10 according to an embodiment of the present disclosure; and

FIG. 14 is a block diagram of a configuration of an image forming device corresponding to a second image forming device sharing setting data in the printing system of FIG. 10 according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It will be further understood that the terms “comprises” and/or “comprising” when used in this specification, specify the presence of stated features, integers, operations, elements, and/or components, but do not preclude the presence or addition of one or more other features, integers, operations, elements, components, and/or groups thereof.

Expressions such as “at least one of,” when preceding a list of elements, modify the entire list of elements and do not modify the individual elements of the list.

It will be understood that, although the terms first, second, etc. may be used herein to describe various elements, these elements may not be limited by these terms. These terms are only used to distinguish one element, component, region, layer or section from another region, layer or section.

The present various embodiments relate to a device for supporting a print service and a method of providing a cloud print service. Therefore, detailed descriptions of contents that are well known to those of ordinary skill in the art are omitted.

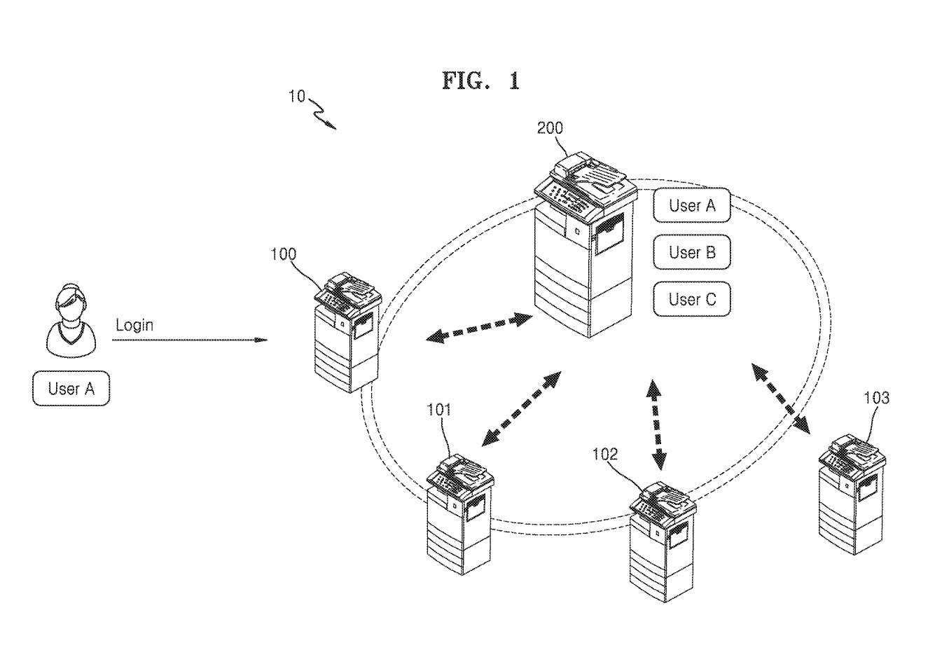

FIG. 1 illustrates a printing system 10 for sharing personalization data according to an embodiment of the present disclosure.

Referring to FIG. 1, the printing system 10 may include a plurality of image forming devices 100, 101, 102, 103, and 200. For example, the printing system 10 may be a system including a plurality of image forming devices connected to a local network used in an enterprise.

The plurality of image forming devices 100, 101, 102, 103, and 200 may be devices that support performances of image forming jobs such as scanning, printing, faxing, etc. like printers, scanners, fax machines, or multi-function products (MFPs). The plurality of image forming devices 100, 101, 102, 103, and 200 may be connected to one another through a wired or wireless network in the printing system 10.

For example, all of the plurality of image forming devices 100, 101, 102, 103, and 200 may be respectively connected to another image forming device. Alternatively, the printing system 10 may be formed in a structure where the image forming devices 100, 101, 102, and 103 are connected to the image forming device 200.

The plurality of image forming devices 100, 101, 102, 103, and 200 included in the printing system 10 may be used by a plurality of users. In other words, the image forming device 100 of the printing system 10 may be shared by a plurality of users in an enterprise, and one user may equally use the plurality of image forming devices 100, 101, 102, 103, and 200. Here, although the plurality of users use the printing system 10, the printing system 10 may provide a job environment appropriate for each of the users.

In detail, the plurality of image forming devices 100, 101, 102, 103, and 200 of the printing system 10 may share personalization data about a user with one another to provide a customized job environment appropriate for the user. Here, the plurality of image forming devices 100, 101, 102, 103, and 200 may include a second image forming device 200 that stores and manages personalization data about users and first image forming devices 100, 101, 102, and 103 that receive the personalization data from the second image forming device 200 and use the personalization data.

Referring to FIG. 1, if user A logs in the first image forming device 100, the first image forming device 100 may receive personalization data about the user A from the second image forming device 200 to provide a user interface, to which the personalization data is applied, to the user A.

Personalization data may be setting information for an image forming job that is stored so as to correspond to a user. For example, the personalization data may include an application provided to a user interface, a current state of the application, and pieces of information about setting of the application.

If the user A logs in, the first image forming device 100 may receive the personalization data about the user A from the second image forming device 200 by using identification information of the user A and provide a user interface applying this. For example, the first image forming device 100 may provide a user interface that is being previously used by the user A in the first image forming device 100 or the other image forming device 101, 102, or 103.

Although the user A uses any image forming device included in the printing system 10, the user A may be provided with a user interface keeping personalization data of the user A and may easily perform an image forming job by using the printing system 10.

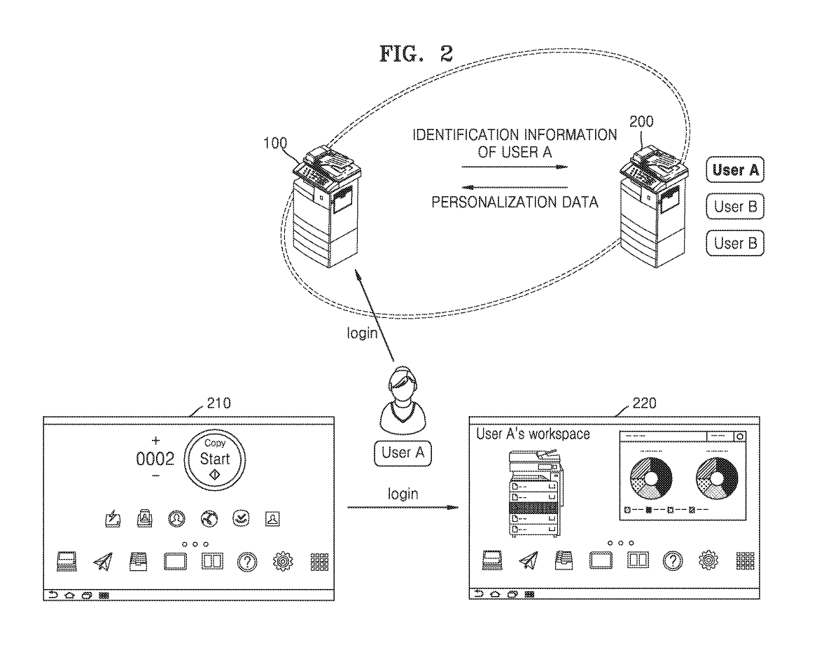

FIG. 2 illustrates a process of providing a user interface by using personalization data shared in the first image forming device 100 according to an embodiment of the present disclosure.

Referring to FIG. 2, a user may log in the first image forming device 100 to be provided with a user interface to which personalization data of the user is applied.

In detail, the user may input user identification information into the first image forming device 100 to log in the first image forming device 100. The user identification information is information that is identified for each user, and the first image forming device 100 may perform a user authentication by using the received user identification information. For example, the user identification information may be information, such as an ID or a phone number of the user or may be information including a password.

If the user authentication succeeds, the first image forming device 100 may transmit the user identification information to the second image forming device 200 to receive personalization data corresponding to the user identification information. The second image forming device 200 may store and manage the personalization data.

The first image forming device 100 may provide a user interface, to which the personalization data is applied, to the user by using the received personalization data. In other words, the first image forming device 100 may change the user interface provided from the first image forming device 100, based on the received personalization data. For example, the first image forming device 100 may change a type of an application displayed on the user interface, a current state of the application, setting of the application, etc. and provide the changed type of application, current state, setting, etc. to the user.

Personalization data may include information about printing setting of a printing application. Also, the personalization data may include address book information of the user. For example, the address book information may be e-mail information or phone number information of another user or account information in a system. Also, the user may transmit an image forming device to the other user by using the address book information provided through the user interface to which the personalization data is applied.

Referring to FIG. 2, the first image forming device 100 may provide a default user interface 210 that is generally provided before the user logs in the first image forming device 100. The default user interface 210 may provide basic applications, and the basic applications may keep default states and default settings.

Here, if the user logs in the first image forming device 100, the first image forming device 100 may provide a user interface 220 to which personalization data of the user is applied. For example, the user interface 220 may provide a user interface that is previously used by the user in the first image forming device 100 or another image forming device. The user interface 220 may display applications that are selected or installed by the user and display states and settings of the applications as they are set by the user.

The user may immediately use an application that is frequently used or setting of the application through the user interface 220 without additional resetting.

Also, personalization data may include location information indicating a location of a personal storage of the user. The personal storage of the user may store an image forming job of the user and may be located in one of a plurality of image forming devices of the printing system 10. The second image forming device 200 may store the location information of the personal storage of the user so as to enable the location information to correspond to user identification information. Here, the first image forming device 100 may receive data of an image forming job from another image forming device of the printing system 10 according to the location information of the personal storage of the user received from the second image forming device 200.

The user may receive personal image forming job data of the user stored in one image forming device from an image forming device of the printing system 10 and use the personal image forming job data.

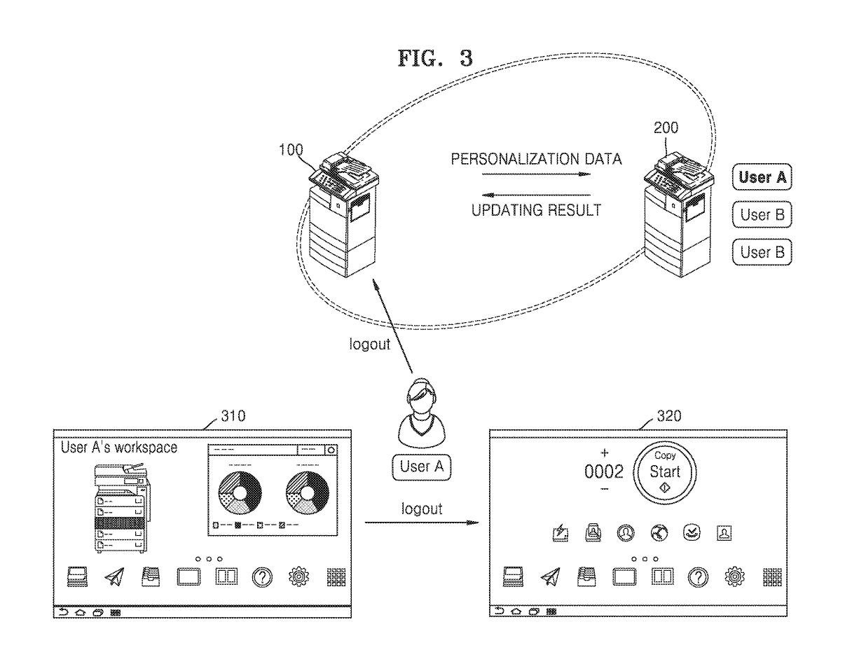

FIG. 3 illustrates a process of sharing personalization data in the first image forming device 100 according to an embodiment of the present disclosure.

Referring to FIG. 3, user A finishes a job in the first image forming device 100 and then logs in the first image forming device 100 to share newly set personalization data with other image forming devices of the printing system 10.

For example, the user A who logs in the first image forming device 100 to be provided with a user interface may change personalization data in a process of performing an image forming job. Here, the first image forming device 100 may transmit personalization data, which is changed to keep a state when the user logs out, to the second image forming device 200. The second image forming device 200 may update personalization data about the user by using received personalization data.

In detail, when the user ends an access through an appropriate process such as logout or the like, the first image forming device 100 may transmit current personalization data with user identification information to the second image forming device 200. If the second image forming device 200 stores personalization data corresponding to the received user identification information, the second image forming device 200 may update the personalization data to newly received personalization data. If the second image forming device 200 does not store the personalization data corresponding to the received user identification information, the second image forming device 200 may store the newly received personalization data as new information.

If there is no change in personalization data by the user, the first image forming device 100 may not update the personalization data. If the access or the like is blocked without passing an appropriate logout process or the like, the first image forming device 100 may also not update newly changed personalization data. Also, the first image forming device 100 may receive information about whether to update the newly changed personalization data, from the user.

As shown in FIG. 3, if the user A logs out, the first image forming device 100 may transmit the personalization data of the user A to the second image forming device 200 and change a user interface 310, to which the personalization data of the user A is applied, into a default user interface 320. The default user interface 320 may be a user interface that is provided with default applications and keeps defaults states and default settings of the applications.

When a user logs out, the first image forming device 100 may manage personalization data to continuously dynamically provide a user-customized interface to the user.

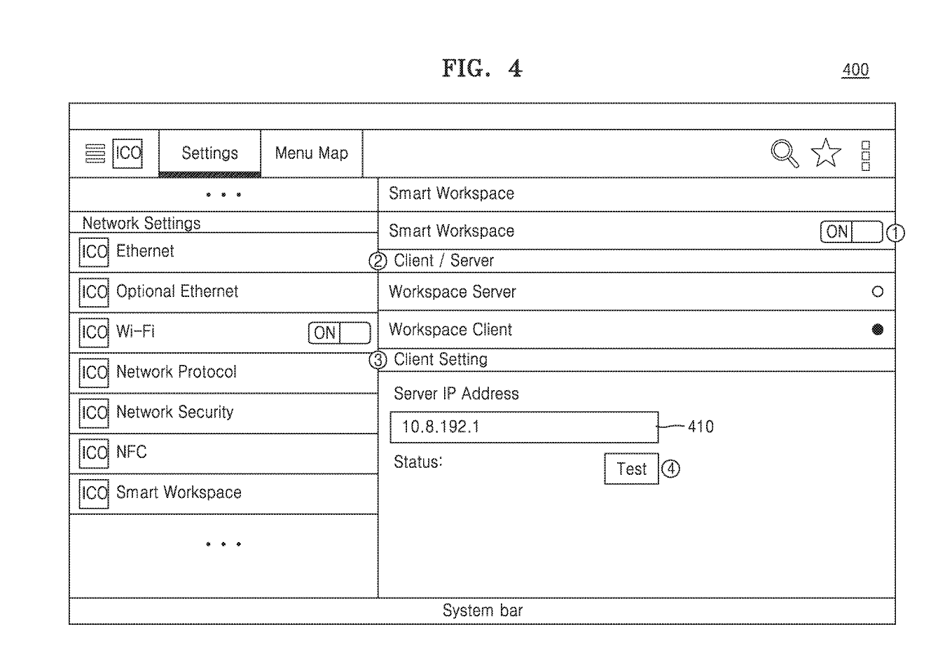

FIG. 4 illustrates a process of setting an environment for sharing personalization data in an image forming device of the printing system 10 according to an embodiment of the present disclosure.

The plurality of image forming devices 100, 101, 102, 103, and 200 of the printing system 10 of FIG. 1 may pre-perform environment settings to share personalization data. For example, the environment settings may be simultaneously performed by a manager or may be individually performed by an image forming device.

For example, referring to FIG. 4, the first image forming device 100 of FIG. 1 may provide a user interface 400 for setting an environment of the first image forming device 100 of the printing system 10. A user may set an environment for sharing personalization data through the user interface 400.

In detail, the first image forming device 100 may receive a user input about whether to share personalization data in the first image forming device 100, from the user through the user interface 400.

For example, if the user sets to share the personalization data in the first image forming device 100, the first image forming device 100 may determine that the first image forming device 100 is included in the printing system 10. If the user sets not to share the personalization data in the first image forming device 100, the first image forming device 100 may determine that the first image forming device 100 is not included in the printing system 10 to provide merely a default user interface.

Also, the first image forming device 100 may receive a user input about whether the first image forming device 100 stores and manages personalization data of users, from the user through the user interface 400.

For example, if the first image forming device 100 is set to a device that stores and manages personalization data, the first image forming device 100 may perform a function of providing a user interface to which the personalization data is applied and a function of storing and managing the personalization data to transmit the personalization data to other image forming devices. For example, the second image forming device 200 of FIG. 1 may be an image forming device set to a device that stores and manages personalization data.

Also, the first image forming device 100 may receive identification information about the second image forming device 200 to which the personalization data will be transmitted through the user interface 400. For example, the identification information about the second image forming device 200 is unique information for identifying the second image forming device 200 and may be a name, a unique number, an internet protocol (IP) address 410, or the like of the second image forming device 200.

The first image forming device 100 may be connected to the second image forming device 200 to which the personalization data will be transmitted by using the received identification information about the second image forming device 200. For example, as shown in FIG. 4, the user may input the IP address of the second image forming device 200 through the user interface 400, and the first image forming device 100 may be connected to the identified second image forming device 200 by using the IP address.

Also, the first image forming device 100 is not limited thereto and thus may identify the second image forming device 200 connected to the first image forming device 100 by using various methods. For example, the first image forming device 100 may identify the second image forming device 200 by using user identification information received from the user. The first image forming device 100 may store information about the second image forming device 200 corresponding to the user identification information.

In other words, the first image forming device 100 may store information about another image forming device that stores personalization data of a user. If the first image forming device 100 receives the user identification information from the user to succeed in a user authentication, the first image forming device 100 may identify the second image forming device 200 corresponding to the user identification information to be connected to the second image forming device 200.

The printing system 10 may differently set the image forming device 200 that stores and manages personalization data of a user to secure a larger storage space and to enable an organic combination of a system and sharing of data.

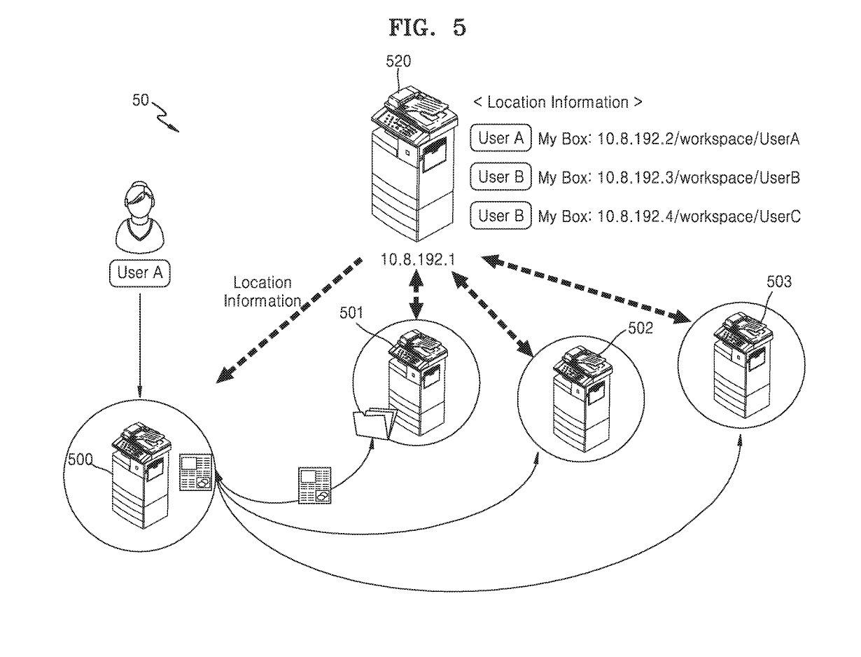

FIG. 5 illustrates a printing system 50 that shares personalization data according to an embodiment of the present disclosure.

Referring to FIG. 5, the printing system 50 may include a plurality of image forming devices 500, 501, 502, 503, and 520. All processes performed in the printing system 10 described above may also be performed in the printing system 50.

Referring to FIG. 5, the printing system 50 may share image forming job data between image forming devices of the printing system 50 by using personalization data.

If user A logs in, the first image forming device 500 may receive personalization data about the user A from the second image forming device 520. Here, the personalization data may include location information indicating a location of a personal storage of a user.

For example, the second image forming device 520 may store the location information of the personal storage of the user so as to enable the location information to correspond to identification information of the user. The location information of the personal storage is information indicating a location of a storage space allocated to the user so as to store data about an image forming job, in particular, may indicate a particular folder of a particular image forming device of the printing system 50.

As shown in FIG. 5, location information of a personal storage of the user A may be “10.8.192.2/workspace/UserA”. “10.8.192.2” may be an IP address of the image forming device 501 of the printing system 50, and “10.8.192.2/workspace/UserA” may be an address of a particular folder of the image forming device 501.

The first image forming device 500 may transmit and receive data about an image forming job with a personal storage of the image forming device 501 by using the received location information. The first image forming device 500 may receive a file stored in the personal storage and print the file in the first image forming device 500 or may store a file scanned in the first image forming device 500 in the personal storage.

If location information of a personal storage corresponding to user identification information does not exist in the second image forming device 520, the first image forming device 500 may generate a new personal storage in a preset location of the first image forming device 500 and transmit location information about the generated new personal storage to the second image forming device 520.

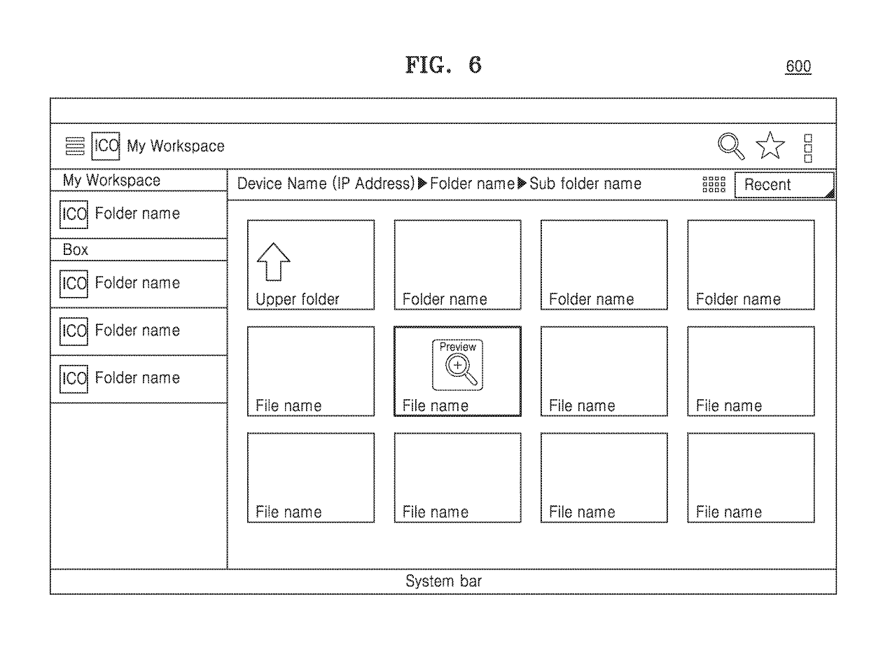

FIG. 6 illustrates a process of managing a personal storage of a user in the first image forming device 100 according to an embodiment of the present disclosure.

Referring to FIG. 6, the first image forming device 100 may provide a user interface 600 for managing a personal storage of a user.

If the user logs in, the first image forming device 100 may receive location information of the personal storage of the user from the second image forming device 200 by using user identification information received from the user. The first image forming device 100 may provide the user interface 600 by using the received location information of the personal storage.

The user interface 600 may display a current state of the personal storage of the user to provide the current state of the personal storage to the user and receive a user input for managing the personal storage.

For example, the first image forming device 100 may receive information about the personal storage from an image forming device indicated by the location information of the personal storage to display the user interface 600. For example, the information about the personal storage may be information about folders included in the personal storage and information about files stored in the personal storage.

The first image forming device 100 may receive preview data of a file stored in the personal storage from an image forming device indicated by the location information of the personal storage to display the user interface 600.

The first image forming device 100 may also receive a request for an image forming job of a file stored in the personal storage from the user through the user interface 600. For example, the user may select the file stored in the personal storage to request a print job. If the print job is requested, the first image forming device 100 may receive the corresponding file from an image forming device indicated by the location information of the personal storage and print the corresponding file.

The first image forming device 100 may also delete, copy, or move a folder and a file stored in the personal storage through the user interface 600 to manage the personal storage.

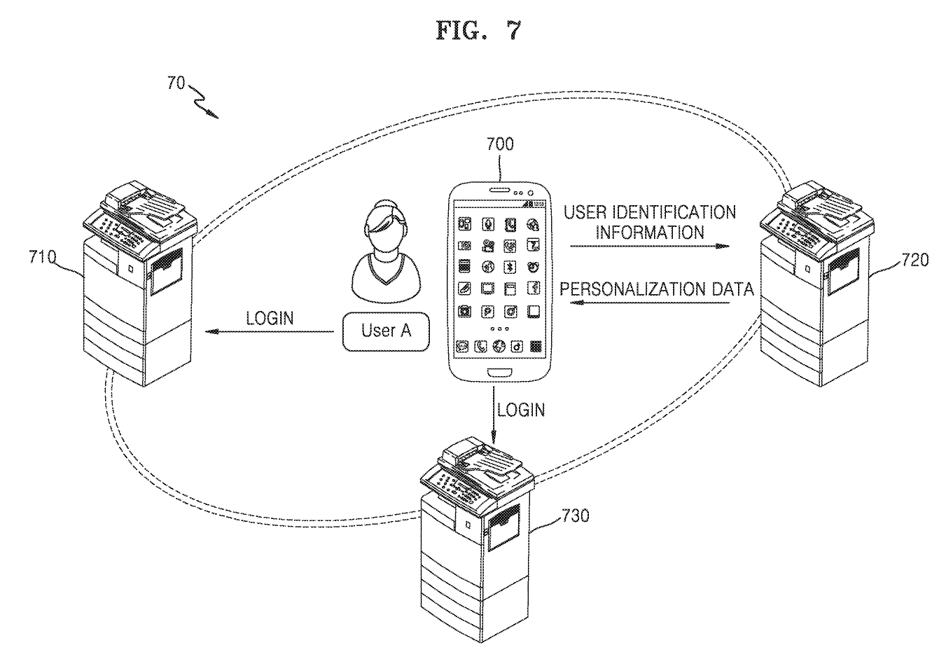

FIG. 7 illustrates a printing system 70 that shares personalization data according to an embodiment of the present disclosure.

Referring to FIG. 7, the printing system 70 may further include a user terminal 700 besides a plurality of image forming devices 710, 720, and 730.

A user may store and manage personalization data by using the user terminal 700. The user terminal 700 may receive the personalization data about the user from the image forming device 720, store the personalization data, and update personalization data changed by the user.

In detail, the user may log in the image forming device 720 through the user terminal 700. The image forming device 720 may receive user identification information from the user terminal 700 to perform a user authentication. If the image forming device 720 succeeds in the user authentication, the image forming device 720 may transmit the personalization data corresponding to the user identification information to the user terminal 700.

The user terminal 700 may provide a user interface for manipulating the image forming device 720 by using the received personalization data. The user terminal 700 may provide a user interface to which the received personalization data is applied. The user may manage the personalization data through the user interface for manipulating the image forming device 720 in the user terminal 700. For example, the user may delete, change, and generate personalization data.

Here, the user terminal 700 may update and store changed personalization data. For example, if the user logs out, the user terminal 700 may store the changed personalization data.

The user may provide consecutive user interfaces in another image forming device 710 or 730 of the printing system 10 by using the personalization data stored in the user terminal 700. If the user terminal 700 newly logs in the image forming device 710, the user terminal 700 may provide a user interface for manipulating the image forming device 710 by using the stored personalization data. The user terminal 700 may provide a user interface to which the stored personalization data is applied.

The user may be dynamically provided with a user-customized interface in an image forming device of the printing system 70 by using the user terminal 700.

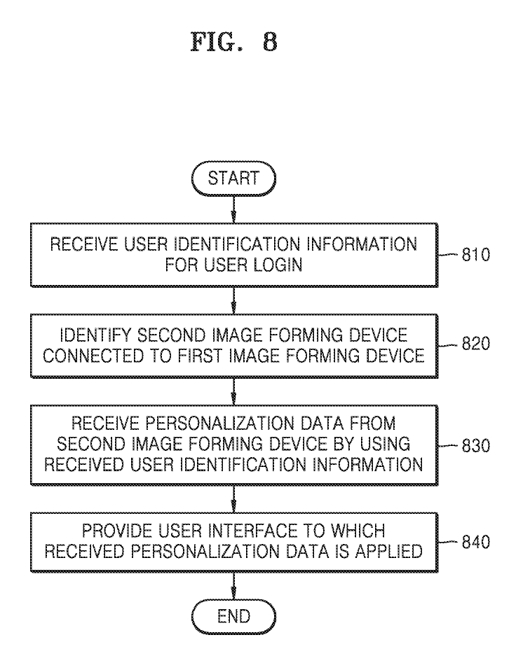

FIG. 8 is a flowchart of a method of sharing personalization data in the first image forming device 100 according to an embodiment of the present disclosure.

The method of FIG. 8 may be, for example, performed by the first image forming device 100 of FIG. 1.

In operation 810, the first image forming device 100 may receive user identification information for user login. The user identification information may be unique information of each user, and the first image forming device 100 may perform a user authentication by using the received user identification information. For example, the user identification information may be information such as an ID or a phone number of the user or may be information including a password. If the first image forming device 100 succeeds in the user authentication, the user may log in the first image forming device 100.

In operation 820, the first image forming device 100 may identify the second image forming device 200 connected to the first image forming device 100.

For example, the first image forming device 100 may identify the second image forming device 200 by using the user identification information received from the user. The first image forming device 100 may store information about the second image forming device 200 corresponding to the user identification information.

The first image forming device 100 may also identify the second image forming device 200 by using identification information about the second image forming device 200 to which the personalization data will be transmitted. For example, the identification information about the second image forming device 200 may be unique information for identifying the second image forming device 200 or may be a name, a unique number, an IP address, or the like of the second image forming device 200. The identification information about the second image forming device 200 may be input from the user or may be pre-stored in the first image forming device 100.

The first image forming device 100 may be connected to the identified second image forming device 200 through a wired or wireless network.

In operation 830, the first image forming device 100 may receive personalization data from the second image forming device 200 by using the received user identification information.

The personalization data may be setting information for an image forming job stored so as to correspond to the user. For example, the personalization data may include an application provided to a user interface, a current state of the application, and information about setting of the application.

Also, the personalization data may include information about printing setting of a printing application. The personalization data may also include address book information of the user. For example, the address book information may be e-mail information or phone number information of another user or account information of a system.

Also, the personalization data may include location information indicating a location of a personal storage of the user.

In operation 840, the first image forming device 100 may provide a user interface to which the received personalization data is applied.

The first image forming device 100 may change the user interface provided in the first image forming device 100, based on the received personalization data. For example, the first image forming device 100 may change a type of an application displayed on the user interface, a current state of the application, setting of the application, etc. and provide the user with the changed type, current state, setting, etc. of the application.

Therefore, the first image forming device 100 may provide a user interface, which is previously used by the user in the first image forming device 100 or another image forming device, as it is. The first image forming device 100 may display applications selected or set by the user on the user interface and may display states and settings of the applications as they are set by the user.

The user may immediately use a frequently used application or setting of the frequently used application through a user interface, to which the personalization data is applied, without additional setting.

Also, the first image forming device 100 may receive data about an image forming job from another image forming device indicated by the location information of the printing system 10 by using location information indicating a location of a personal storage. The user may receive data about a personal image forming job of the user stored in one image forming device from an image forming device of the printing system 10 and use the data.

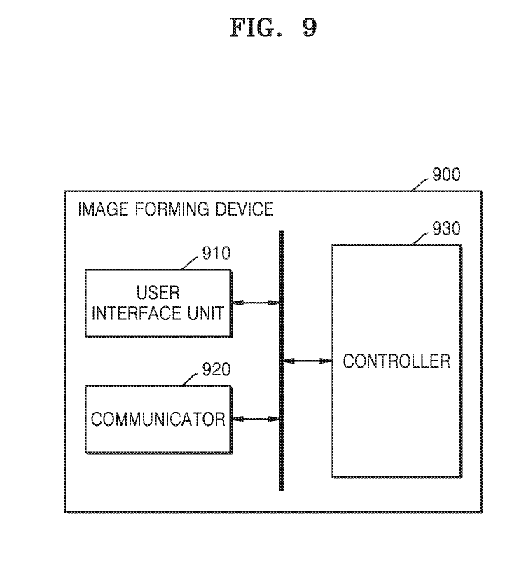

FIG. 9 is a block diagram of a configuration of an image forming device 900 that shares personalization data according to an embodiment of the present disclosure.

Referring to FIG. 9, the image forming device 900 may include a user interface unit 910, a communicator 920, and a controller 930. The controller 930 includes at least one hardware processor. FIG. 9 illustrates merely elements related to the present embodiment to prevent characteristics of the present embodiment from being unclear. However, it will be understood by those of ordinary skill in the art that other general-purpose hardware elements may be included besides hardware elements of FIG. 9.

The user interface unit 910 may be a hardware element for providing information to a user and receiving an input from the user. The user interface 910 may be realized as a monitor having a display function, a display such as a touch screen, a liquid crystal display (LCD), a light-emitting diode (LED), or the like, a touch panel having an input function, a keyboard, a mouse, or an input device such as a physical button or the like.

The user interface unit 910 may provide a user interface for receiving user identification information and receive the user identification information through the user interface.

The user interface unit 910 may provide a user interface for setting an environment of the image forming device 900. The user interface unit 910 may receive a user input about whether to share personalization data, a user input about whether to store and manage the personalization data, identification information about a second image forming device, etc. from the user through the user interface for setting the environment.

If the personalization data is received, the user interface unit 910 may also provide a user interface to which the received personalization data is applied.

Also, the user interface unit 910 may provide a user interface for managing a personal storage of the user by using location information of the personal storage. The user interface unit 910 may display a current state of the personal storage of the user through the user interface for managing the personal storage to provide the current state to the user and receive a user input for managing the personal storage.

The user interface unit 910 may receive preview data of a file stored in the personal storage from an image forming device indicated by the location information of the personal storage and display the preview data. The user interface unit 910 may also receive a request for an image forming job of the file stored in the personal storage from the user. For example, the user may select the file stored in the personal storage to request a printing job.

Besides these, the user interface unit 910 may delete, copy, or move a folder and a file stored in the personal storage to manage the personal storage.

The communicator 920 is an element for transmitting and receiving data with an external device through a wired and/or wireless communication and may include a WiFi module, a WiFi Direct module, a Bluetooth module, an Ethernet module, etc.

The communicator 920 may transmit user identification information to a second image forming device and receive personalization data from the second image forming device.

The communicator 920 may also receive location information of the personal storage of the user from the second image forming device by using the user identification information. Also, the communicator 920 may transmit changed personalization data to the second image forming device.

The communicator 920 may receive image forming job data from the second image forming device or a third image forming device by using the location information of the personal storage. Also, the communicator 920 may transmit various types of control signals for managing the personal storage to the second image forming device or the third image forming device.

The controller 930 is an element for controlling an overall operation of the image forming device 900, for example, may include a central processing unit (CPU).

The controller 930 may perform a user authentication by using the received user identification information. The controller 930 may check a pre-stored available user list based on the user identification information. If the controller 930 succeeds in the user authentication, the controller 930 may control to provide a user interface to which the received personalization data is applied.

The controller 930 may also identify the second image forming device connected to the image forming device 900. For example, the controller 930 may identify the second image forming device that will be connected to the image forming device 900, by using the user identification information. Also, the controller 930 may identify the second image forming device that will be connected to the image forming device 900, by using identification information of the second image forming device.

The controller 930 may control to provide a user interface to which received personalization data is applied. For example, the controller 930 may change at least one selected from an application provided from the user interface, a current state of the application, and setting of the application, by using the received personalization data.

If user login ends, the controller 930 may control to update the personalization data in the second image forming device by using the user identification information.

If the location information of the personal storage of the user is received, the controller 930 may control to receive image forming job data from the third image forming device according to the received location information. The controller 930 may control to transmit image forming job data to the second image forming device or the third image forming device according to the received location information.

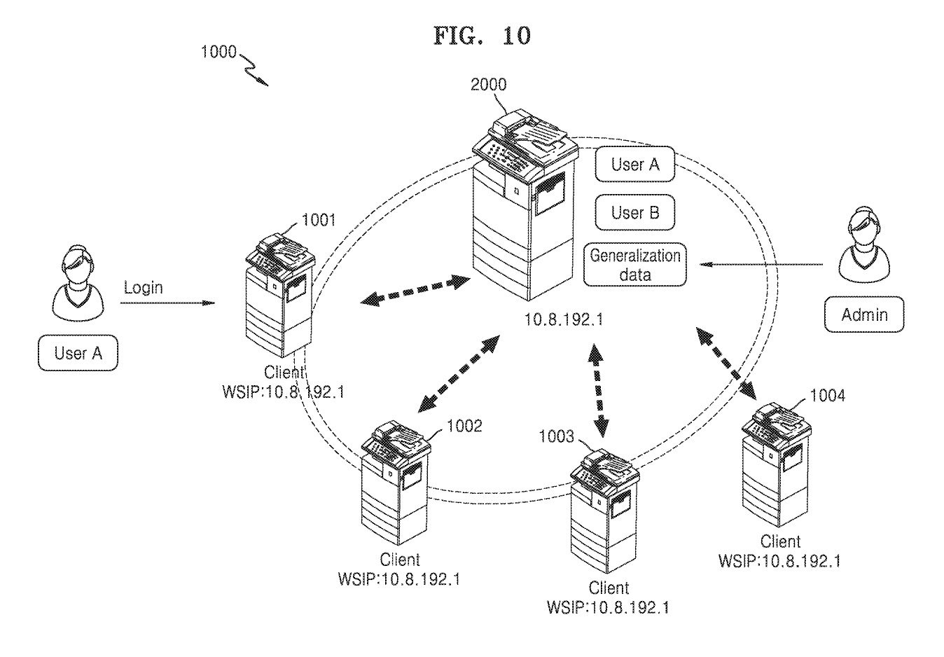

FIG. 10 illustrates a printing system 1000 for sharing setting data according to an embodiment of the present disclosure.

Referring to FIG. 10, the printing system 1000 according to the present embodiment may include a plurality of image forming devices 1001, 1002, 1003, 1004, and 2000. For example, the printing system 1000 may be a system including a plurality of image forming devices that are connected to one another in a local network environment such as a network in an enterprise.

The plurality of image forming devices 1001, 1002, 1003, 1004, and 2000 may be devices that support performances of image forming jobs such as scanning, printing, faxing, etc. like scanners, fax machines, MFPs, etc. and may be connected to one another through a wired or wireless network in the printing system 1000.

The plurality of image forming devices 1001, 1002, 1003, 1004, and 2000 may include the second image forming device 2000 that stores and administers setting data of the image forming jobs and the first image forming devices 1001, 1002, 1003, and 1004 that receive the setting data from the second image forming device 2000 and use the setting data.

Here, the setting data of the image forming jobs may include personalization data that indicates personalization data of each of users and generalization data that may be applied at the same time without differences between the users.

For example, the personalization data used in the printing system 100 according to the present embodiment may be equal to personalization data used in the printing system 100 according to the embodiment of FIG. 1. In other words, the first image forming devices 1001, 1002, 1003, and 1004 of the printing system 1000 of the present embodiment may perform the same functions as the first image forming devices 100, 101, 102, and 103 of FIG. 1, and the second image forming device 2000 of the printing system 1000 of the present embodiment may perform the same function as the image forming device 200 of FIG. 1.

Also, the generalization data used in the printing system 1000 according to the present embodiment may be data including information about a job environment applied to a plurality of image forming devices at the same time by an administrator. Like the personalization data, the generalization data may include pieces of information about an application provided to a user interface, a state of the application, and setting of the application. However, differently from the personalization data, the generalization data may not include identification information of an image forming device or identification information of image forming devices that may not be the same according to users, and identification information of an IP address or the like. The generalization data may be used for an image forming device and default setting of the image forming device.

The administrator of the printing system 1000 of the present embodiment may input the generalization data to administer the plurality of image forming devices 1001, 1002, 1003, 1004, and 2000 of the printing system 1000 at the same time.

In detail, referring to FIG. 10, the second image forming device 2000 may receive the generalization data from an administrator Admin, and store and administer the generalization data. For example, the administrator Admin may directly input the generalization data through a user interface included in the second image forming device 2000 or may transmit the generalization data to the second image forming device 2000 by using another user terminal connected to the second image forming device 2000. Here, an administrator access control may be demanded so as to enable the administrator Admin to input the generalization data into the second image forming device 2000.

The second image forming device 2000 may store and administer the received generalization data, and if the first image forming devices 1001, 1002, 1003, and 1004 demand the personalization data, may transmit the generalization data along with the personalization data to the first image forming devices 1001, 1002, 1003, and 1004. Here, unnecessary transmissions may be prevented by using version information of setting data to improve transmission efficiency and supplementation, thereby further efficiently administering the setting data.

Version information of setting data according to an embodiment may be information for administering updating states of setting data of the plurality of image forming devices 1001, 1002, 1003, 1004, and 2000, for example, may be numbers indicating the numbers of times being updated.

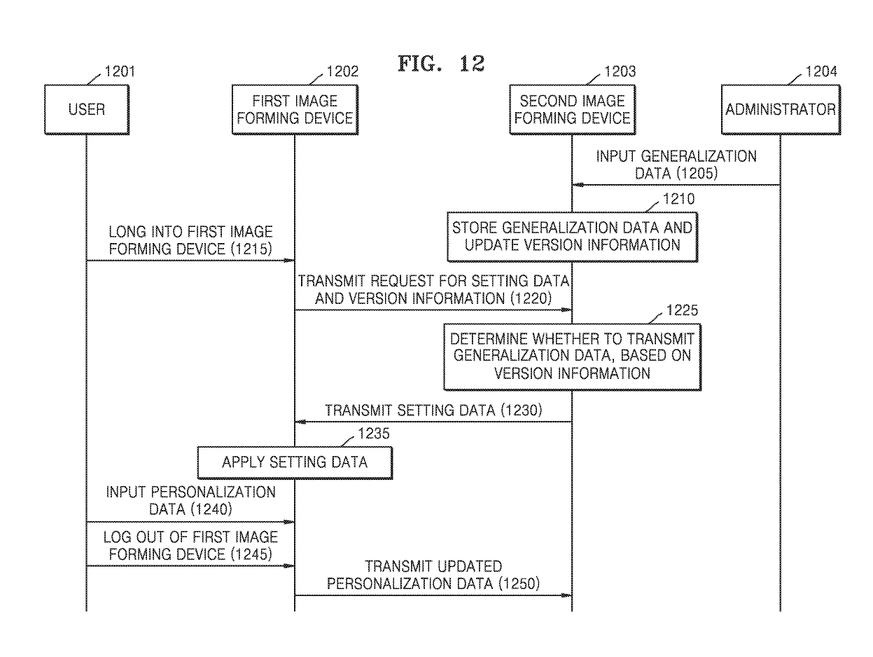

The second image forming device 2000 according to the embodiment may compare version information of setting data of the second image forming device 2000 with version information of setting data of the first image forming devices 1001, 1002, 1003, and 1004 to determine setting data that will be transmitted to the first image forming devices 1001, 1002, 1003, and 1004. A detailed operation process of the second image forming device 2000 according to an embodiment will be described later with reference to FIGS. 12 through 14.

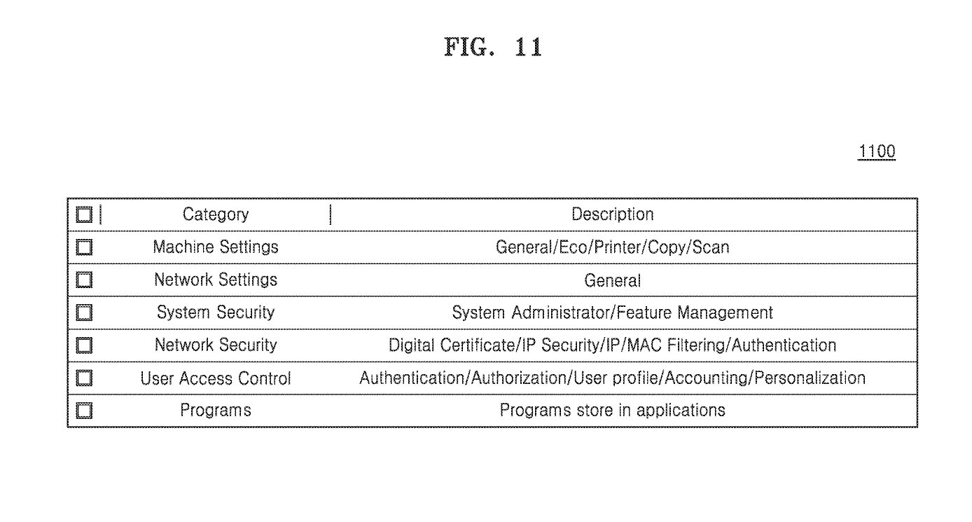

FIG. 11 illustrates generalization data used in the printing system 1000 of FIG. 10 according to an embodiment of the present disclosure.

The administrator of the printing system 1000 according to an embodiment may input generalization data, which will be commonly applied in the printing system 1000, into the second image forming device 2000. For example, referring to FIG. 11, the second image forming device 2000 may provide a user interface 1100 to the administrator through a user interface unit included in the second image forming device 2000 or another user terminal connected to the second image forming device 2000 and may receive items of the generalization data.

The administrator may select items of the generalization data, which will be commonly applied in the printing system 1000, and input generalization data of the selected items through the user interface 1100.

For example, if the user interface 1100 including a machine setting item, a network setting item, a system security item, a network security item, a user access control item, and a program item is provided, the administrator may select the network security item and the user access control item as items of the generalization data that will be commonly applied in the printing system 1000.

Also, the administrator may input detailed generalization data for the network security item and the user access control item that are selected. For example, the administrator may input generalization data indicating a level of network security for the network security item and input generalization data indicating a level of a user access control for the user access control item.

In addition, the administrator may enable the user to select and apply some or all of items of pieces of the input generalization data. For example, if the administrator inputs generalization data including a machine setting item, a network setting item, a system security item, a network security item, a user access control item, and a program item into the second image forming device 2000, the first image forming devices 1001, 1002, 1003, and 1004 may acquire the generalization data from the second image forming device 2000 to provide the user interface 1100 to the user. The user may select items, to which the generalization data will be applied, and use generalization data of some or all of items through the user interface 1100.

Alternatively, the user may select whether to apply generalization data or personalization data.

FIG. 12 is a sequence diagram of a method of sharing setting data in the printing system 1000 of FIG. 10 according to an embodiment of the present disclosure.

The method of sharing the setting data in the printing system 1000 according to the present embodiment may be performed by a first image forming device 1202 and a second image forming device 1203.

Referring to FIG. 12, in operation 1205, an administrator 1204 of the printing system 1000 according to the present embodiment may input generalization data, which will be commonly applied in the printing system 100, into the second image forming device 1203. For example, the administrator 1204 may directly input the generalization data through a user interface included in the second image forming device 1203 or may transmit the generalization data to the second image forming device 1203 through another user terminal connected to the second image forming device 1203.

If the generalization data is received, the second image forming device 1203 may update existing generalization data as the received generalization data in operation 1210. Also, if received setting data is generalization data, the second image forming device 1203 may update version information of the setting data. For example, the version information may be a number indicating the number of times being updated. If the generalization data is received, and current version information is 1, the second image forming device 1203 may increase version information by 1 to update the version information as 2.

Although the setting data and the version information of the setting data are updated, the second image forming device 1203 may not transmit the setting data and the version information but may wait until a request for the setting data is made.

In operation 1215, a user 1201 may log into the first image forming device 1202 to perform an image forming job by using the first image forming device 1202.

If the user 1201 logs into the first image forming device 1202, the first image forming device 1202 may transmit a request for the setting data to the second image forming device 1203 in operation 1220. Here, the setting data may include personalization data and generalization data. The first image forming device 1202 may transmit user identification information of the user 1201 for acquiring the personalization data and version information of setting data of the first image forming device 1202 for acquiring the generalization data along with the request for the setting data to the second image forming device 1203.

If the request for the setting data is received, the second image forming device 1203 may determine setting data that will be transmitted to the first image forming device 1202 in operation 1225.

In detail, the second image forming device 1203 may determine at least one selected from the personalization data and the generalization data.

For example, the second image forming device 1203 may determine personalization data corresponding to the user identification information received from the first image forming device 1202 among pieces of stored personalization data.

Also, the second image forming device 1203 may determine whether to transmit generalization data stored in the second image forming device 1203 to the first image forming device 1202 by using the version information of the received setting data of the first image forming device 1202. For example, the second image forming device 1203 may compare the version information of the setting data of the first image forming device 1202 with version information of setting data of the second image forming device 1203 to determine whether the version information of the setting data of the first image forming device 1202 is up-to-date.

The second image forming device 1203 may determine to transmit generalization data to the first image forming device 1202 merely when the version information of the setting data of the first image forming device 1202 is not up-to-date.

For example, if the version information of the setting data of the first image forming device 1202 is up-to-date, the second image forming device 1203 may determine to transmit personalization data to the first image forming device 1202. If the version information of the setting data of the first image forming device 1202 is not up-to-date, the second image forming device 1203 may determine to transmit the personalization data and the generalization data to the first image forming device 1202.

Here, the version information of the setting data of the first image forming device 1202 may be compared with a size of version information of setting data of the second image forming device 1203 to determine whether the version information of the setting data of the first image forming device 1202 is up-to-date. For example, if the version information of the setting data of the first image forming device 1202 is the same as the version information of the setting data of the second image forming device 1203, the version information of the setting data of the first image forming device 1202 may be up-to-date. If the version information of the setting data of the first image forming device 1202 is information having a lower number than the version information of the setting data of the first image forming device 1202, the version information of the setting data of the first image forming device 1202 may not be up-to-date.

In operation 1230, the second image forming device 1203 may transmit at least one selected from the determined personalization data and generalization data to the first image forming device 1202.

In operation 1235, the first image forming device 1202 may provide a user interface, to which received setting data is applied, by using the received setting data.

Here, the first image forming device 1202 may store the received setting data in the first image forming device 1202 to update setting data. For example, if personalization data is included in the received setting data, the first image forming device 1202 may update personalization data of the user 1201 who logs into the first image forming device 1202. Also, if generalization data is included in the received setting data, the first image forming device 1202 may update the generalization data. If the generalization data is updated, the first image forming device 1202 may update the version information of the setting data of the first image forming device 1202.

If the version information of the setting data of the first image forming device 1202 is updated, the first image forming device 1202 may increase the version information by 1 to update the version information. Also, the first image forming device 1202 may receive the version information of the setting data of the first image forming device 1203 to change the version information of the setting data of the first image forming device 1202 into the same version information as the version information of the setting data of the second image forming device 1203 so as to update the version information.

Also, the first image forming device 1202 may determine setting data, which will be applied to a user interface, among pieces of updated setting data. The first image forming device 1202 may determine the setting data, which will be applied to the user interface, based on an input of the user 1201.

In operation 1240, the first image forming device 1202 may receive new personalization data from the user 1201 who logs into the first image forming device 1202 to update the personalization data. Here, the user 1201 may newly input merely personalization data but may update generalization data.

If the user 1201 logs out of the first image forming device 1202 in operation 1245, the first image forming device 1202 may transmit the updated personalization data to the second image forming device 1202 in operation 1250. Here, the first image forming device 1202 may transmit merely the updated personalization data and may not transmit the generalization data. The second image forming device 1203 that receives the personalization data may update the personalization data.

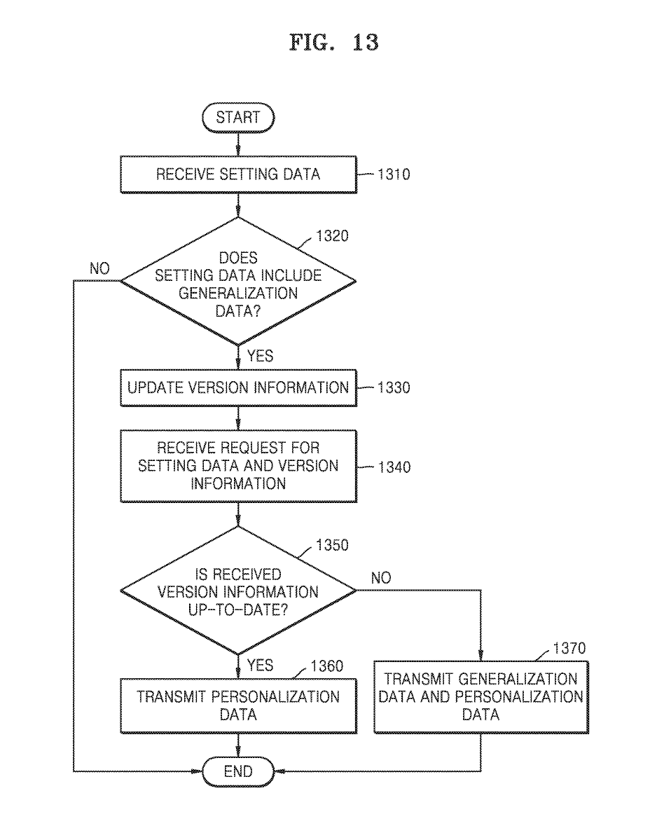

FIG. 13 is a flowchart of a method of sharing setting data in the printing system 1000 of FIG. 10 according to an embodiment of the present disclosure.

The method of sharing the setting data according to the present embodiment may be performed by the second image forming device 2000 of FIG. 10.

Referring to FIG. 13, in operation 1310, the second image forming device 2000 may receive setting data. Here, the setting data may be data including at least one selected from personalization data and generalization data.

For example, the second image forming device 2000 may receive the generalization data from an administrator, may receive personalization data from a user, or may receive personalization data from other image forming devices (1001, 1002, 1003, and 1004 of FIG. 10).

If the setting data is received, the second image forming device 2000 may determine whether the received setting data includes generalization data in operation 1320.

If the received setting data does not include the generalization data, the second image forming device 2000 may update the received personalization data and end a job.

If the received setting data includes the generalization data, the second image forming device 2000 may update version information of the setting data of the image forming device 2000 in operation 1330.

In operation 1340, the second image forming device 2000 may receive a request for the setting data. For example, the second image forming device 2000 may receive requests for setting data from the other image forming devices 1001, 1002, 1003, and 1004. Here, the second image forming device 2000 may receive version information of the setting data of the other image forming devices 1001, 1002, 1003, and 1004 together.

In operation 1350, the second image forming device 2000 may determine whether the version information of the setting data of the other image forming devices 1001, 1002, 1003, and 1004 are up-to-date. The second image forming device 2000 may compare the version information of the setting data of the second image forming device 2000 with the version information of the setting data of the other image forming devices 1001, 1002, 1003, and 1004 to determine whether the version information of the setting data of the other image forming devices 1001, 1002, 1003, and 1004 is up-to-date. For example, if the version information of the setting data of the other image forming devices 1001, 1002, 1003, and 1004 are the same as the version information of the setting data of the second image forming device 2000, the second image forming device 2000 may determine that the version information of the setting data of the other image forming devices 1001, 1002, 1003, and 1004 is up-to-date.

If the received version information is up-to-date, the second image forming device 2000 may transmit personalization data to the other image forming devices 1001, 1002, 1003, and 1004 in operation 1360.

If the received version information is not up-to-date, the second image forming device 2000 may transmit the generalization data and the personalization data to the other image forming devices 1001, 1002, 1003, and 1004 in operation 1370.

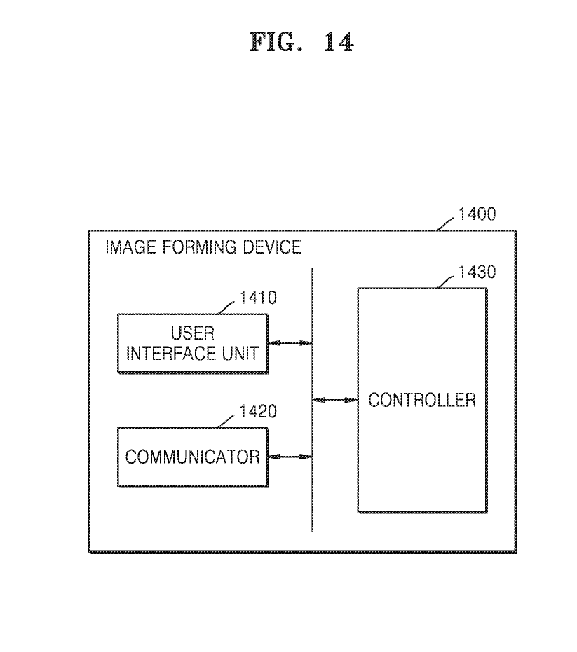

FIG. 14 is a block diagram of a configuration of an image forming device 1400 corresponding to the second image forming device 2000 for sharing setting data in the printing system 1000 of FIG. 10 according to an embodiment of the present disclosure.

Referring to FIG. 14, the image forming device 1400 according to the present embodiment may include a user interface unit 1410, a communicator 1420, and a controller 1430. Merely elements associated with the present embodiment will be described in FIG. 14 to prevent characteristics of the present embodiment from blurring. However, it will be understood by those of ordinary skill in the art that other general-purpose hardware elements may be included besides hardware elements of FIG. 9.

The user interface unit 1410 may be a hardware element that provides information to a user or an administrator and receives an input from the user or the administrator. The user interface unit 1410 may be realized as a display such as a monitor, a touch screen, a LCD, a LED, or the like having a display function or an input device such as a touch panel, a keyboard, a mouse, a physical button, or the like having an input function.

The user interface unit 1410 may provide a user interface for receiving user identification information and receive the user identification information from the user through the user interface. The user interface unit 1410 may also provide a user interface for setting an environment of the image forming device 1400. Also, the user interface unit 1410 may provide the user with a user interface for receiving personalization data and provide the user with a user interface to which the personalization data is applied.

Also, the user interface unit 1410 may provide the administrator with a user interface for receiving generalization data to receive the generalization data from the administrator. An administrator access control may be demanded so as to enable the administrator to input the generalization data.

The communicator 1420 may be an element for transmitting and/or receiving data with an external device through wired and/or wireless communications and may include a WiFi module, a WiFi Direct module, a Bluetooth module, an Ethernet module, etc.

The communicator 1420 may receive generalization data from a terminal of the administrator installed outside the image forming device 1400.

The communicator 1420 may receive requests for setting data from other image forming devices (e.g., 1001, 1002, 1003, and 1004 of FIG. 10). The communicator 1420 may receive user identification information or version information of setting data of the other image forming devices from the other image forming devices.

The communicator 1420 may transmit setting data, which is determined by the controller 1430, to other image forming devices that request the setting data.

The controller 1430 is an element for controlling an overall operation of the image forming device 1400, for example, may include a CPU.

The controller 1430 may receive information about an administrator access control from the administrator to perform an administrator authentication. If the administrator authentication succeeds, the controller 1430 may control the user interface unit 1410 to provide a user interface for inputting the generalization data.

The controller 1430 may also determine whether the setting data received through the communicator 1420 includes the generalization data. The controller 1430 may store the setting data received through the communicator 1420 in a storage unit (not shown) to update the setting data. Here, the received setting data may include at least one selected from the personalization data and the generalization data. If the received setting data includes the generalization data, the controller 1430 may update version information of the setting data of the image forming device 1400.

If the communicator 1420 receives a request for the setting data, the controller 1430 may determine whether version information of setting data of another image forming device that transmits the request is up-to-date. The controller 1430 may compare the version information of the setting data of the image forming device 1400 with the version information of the setting of the other image forming device to determine whether the version information of the setting data of the other image forming device.

If the version information of the setting data of the other image forming devices is up-to-date, the controller 1430 may transmit merely personalization data in response to the request for the setting data. If the version information of the setting data of the other image forming device is not up-to-date, the controller 1430 may transmit personalization data and generalization data in response to the request for the setting data.

The above-described method may be written as a computer program and may be implemented in a general-use digital computer that executes the program using a non-transitory computer readable recording medium. Also, a structure of data used in the above-described method may be recorded on the non-transitory computer readable medium through several units. Examples of the non-transitory computer readable recording medium include magnetic storage media (e.g., read only memory (ROM), floppy disks, hard disks, etc.), optical recording media (e.g., compact disc (CD)-ROMs, or digital versatile discs (DVDs)), etc.

It should be understood that various embodiments described herein should be considered in a descriptive sense only and not for purposes of limitation. Descriptions of features or aspects within each embodiment should typically be considered as available for other similar features or aspects in other various embodiments.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of sharing personalization data in a first image forming device, the method comprising:
receiving user identification information for user login from a user;
identifying a second image forming device connected to the first image forming device;
receiving the personalization data from the second image forming device based on the received user identification information; and
providing a user interface to which the received personalization data is applied.

2. The method of claim 1, further comprising:
if the user login ends, updating the personalization data in the second image forming device based on the user identification information.

3. The method of claim 1, further comprising:
receiving location information of a personal storage device of the user from the second image forming device based on the user identification information; and
receiving image forming job data from a third image forming device according to the received location information.

4. The method of claim 1, further comprising:
receiving location information of a personal storage device of the user from the second image forming device based on the user identification information; and
transmitting image forming job data to at least one of the second image forming device and a third image forming device according to the received location information.

5. The method of claim 1, wherein the providing of the user interface comprises changing at least one of an application provided from the user interface, a current state of the application, and a setting of the application, based on the received personalization data.

6. The method of claim 1, wherein the identifying of the second image forming device comprises identifying the second image forming device connected to the first image forming device based on the user identification information.

7. The method of claim 1, wherein the identifying of the second image forming device comprises identifying the second image forming device connected to the first image forming device based on pre-stored identification information of the second image forming device.

8. The method of claim 1, further comprising:
performing authentication of the user based on the received user identification information,
wherein if the authentication succeeds, the user interface to which the received personalization data is applied is provided.

9. A first image forming device comprising:
a user interface unit configured to receive user identification information for user login from a user;
a communicator configured to receive personalization data from a second image forming device based on the received user identification information; and
a processor configured to:
identify the second image forming device connected to the first image forming device, and
control providing of a user interface to which the received personalization data is applied.

10. The first image forming device of claim 9, wherein if the user login ends, the processor is further configured to control updating of the personalization data in the second image forming device based on the user identification information.

11. The first image forming device of claim 9,
wherein the communicator is further configured to receive location information of a personal storage device of the user from the second image forming device based on the user identification information, and
wherein the processor is further configured to control receiving of image forming job data from a third image forming device according to the received location information.

12. The first image forming device of claim 9,
wherein the communicator is further configured to receive location information of a personal storage device of the user from the second image forming device based on the user identification information, and
wherein the processor is further configured to control transmitting of image forming job data to at least one of the second image forming device and a third image forming device according to the received location information.

13. The first image forming device of claim 9, wherein the processor is further configured to change at least one of an application provided from the user interface, a current state of the application, and a setting of the application, based on the received personalization data.

14. The first image forming device of claim 9, wherein the processor is further configured to identify the second image forming device connected to the first image forming device based on the user identification information.

15. The first image forming device of claim 9, wherein the processor is further configured to identify the second image forming device connected to the first image forming device based on pre-stored identification information of the second image forming device.

16. The first image forming device of claim 9, wherein the processor is further configured to:
perform authentication of the user based on the received user identification information, and
control, if the authentication succeeds, providing of a user interface to which the received personalization data is applied.

17. A computer readable recording medium having recorded thereon a program configured to be executed by at least one processor, the program including instructions that when executed by the at least one processor cause the at least one processor to control:
receiving user identification information for user login from a user;
identifying a second image forming device connected to a first image forming device;
receiving the personalization data from the second image forming device based on the received user identification information; and
providing a user interface to which the received personalization data is applied.
